(19) United States
(12) Patent Application Publication
(10) Pub. No.: US 2019/0061411 A1
(43) Pub. Date: Feb. 28, 2019

(54) Omnibearing Writable Fountain Pen

(71) Applicant: Yee-Shang LAI, Hualien County (TW)

(72) Inventor: Yee-Shang LAI, Hualien County (TW)

(21) Appl. No.: 15/803,192

(22) Filed: Nov. 3, 2017

(30) Foreign Application Priority Data
Aug. 24, 2017 (TW) 106212506

(51) Int. Cl. B43K 1/02; B43K 5/18

(52) U.S. Cl. CPC B43K 1/02; B43K 5/18

(57) ABSTRACT

The present invention provides an omnibearing writable fountain pen, comprising: a shaft component in which an ink reserve chamber is contained; a feed component arranged at the front end of the shaft component to deliver ink reserved in the ink reserve chamber; a nib component including two nibs, each nib having a middle slit, the two nibs being stacked with each other in such a manner that a horizontal gap is disposed between the two nibs so as to form a nib tip having at least four ink channels in a front end of the two nibs, wherein each ink channel is connected through the middle slit and the feed component to the ink reserve chamber, resulting in an advantageous characteristic that makes the omnibearing writable fountain pen of the present invention omnibearing writable.

### FIELD OF THE INVENTION

The present invention relates to a fountain pen, and more particularly relates to an omnibearing writable fountain pen.

### BACKGROUND OF THE INVENTION

Following the trend of practicing calligraphy with stiff pen on the rise, more and more people have enjoyed writing again with a pen. A fountain pen is used mainly in the situations such as formal document writing or signing documents like books. The prior fountain pens include mainly a feed and a nib.

However, limited to the design of the nib of prior arts, when writing upside down with the feed appearing above the nib, a slip of the nib is closed, leading to failure of capillarity (also referred to as capillary action which is applied to draw the ink) such that the ink-flow is blocked. Therefore, most of the fountain pen can only be used to write with the nib appearing above the feed, otherwise when writing upside down or in other orientations, the ink-flow can be disturbed. In view of this, a fountain pen that can be used to write right side up and upside down is sold in the market. However, this fountain pen is still not sufficiently omnibearing writable.

### SUMMARY OF THE INVENTION

Therefore, an objective of the present invention is to provide an omnibearing writable fountain pen, such that the fountain pen can be used to write in all directions.

In order to achieve the above, the present invention provides an omnibearing writable fountain pen, comprising: a shaft component in which an ink reserve chamber is contained; a feed component arranged at the front end of the shaft component to deliver ink reserved in the ink reserve chamber; a nib component including two nibs, each nib having a middle slit, the two nibs being stacked with each other in such a manner that a horizontal gap is disposed between the two nibs so as to form a nib tip having at least four ink channels in a front end of the two nibs, wherein each ink channel is connected through the middle slit and the feed component to the ink reserve chamber.

In one embodiment of the present invention, an omnibearing writable fountain pen is provided that the nib tip is in form of a sphere.

In one embodiment of the present invention, an omnibearing writable fountain pen is provided that the sphere includes two hemispheres, each hemisphere located on one nib.

In one embodiment of the present invention, an omnibearing writable fountain pen is provided that the horizontal gap extends along a bisecting line of the sphere to bisect the sphere.

In one embodiment of the present invention, an omnibearing writable fountain pen is provided that the middle slit extends along a center line of the nib to bisect the hemisphere.

In one embodiment of the present invention, an omnibearing writable fountain pen is provided that the two nibs are arranged as an upper nib and a lower nib, an angle between two side wall surfaces, in up and down direction, of the middle slit formed at the upper nib is between 0°20′0″ and 0°30′0″.

In one embodiment of the present invention, an omnibearing writable fountain pen is provided that the nib component is two detachable nibs.

In one embodiment of the present invention, an omnibearing writable fountain pen is provided that the nib component is formed integrally.

By means of the technology used by the omnibearing writable fountain pen of the present invention, the middle slit forms the ink channels on the front and rear sides of the nib tip, and the horizontal gap forms the ink channels on the left and right sides of the nib tip by allowing these ink channels to communicate with the ink reserve chamber in such a manner that the front, rear, left and right sides of the nib tip can have ink-flow. This advantageous characteristic combining with the adhesive force between ink and paper makes the omnibearing writable fountain pen of the present invention omnibearing writable, thereby improving the convenience of use because a user will not have to take care of the direction of the nib when picking up the fountain pen and starting to write.

### BRIEF DESCRIPTION OF THE DRAWINGS

FIG. 1 is an isometric view illustrating an omnibearing writable fountain pen according to the first embodiment of the present invention;

FIG. 2 is a bottom schematic view illustrating two nibs of the omnibearing writable fountain pen according to the first embodiment of the present invention;

FIG. 3 is a partial exploded schematic side view illustrating the omnibearing writable fountain pen according to the first embodiment of the present invention;

FIG. 4 is a partial schematic side view illustrating the omnibearing writable fountain pen according to the first embodiment of the present invention;

FIG. 5 is a schematic front view illustrating the omnibearing writable fountain pen according to the first embodiment of the present invention;

FIG. 6 is a partial schematic side view illustrating the omnibearing writable fountain pen according to the second embodiment of the present invention.

### DETAILED DESCRIPTION OF THE PREFERRED EMBODIMENTS

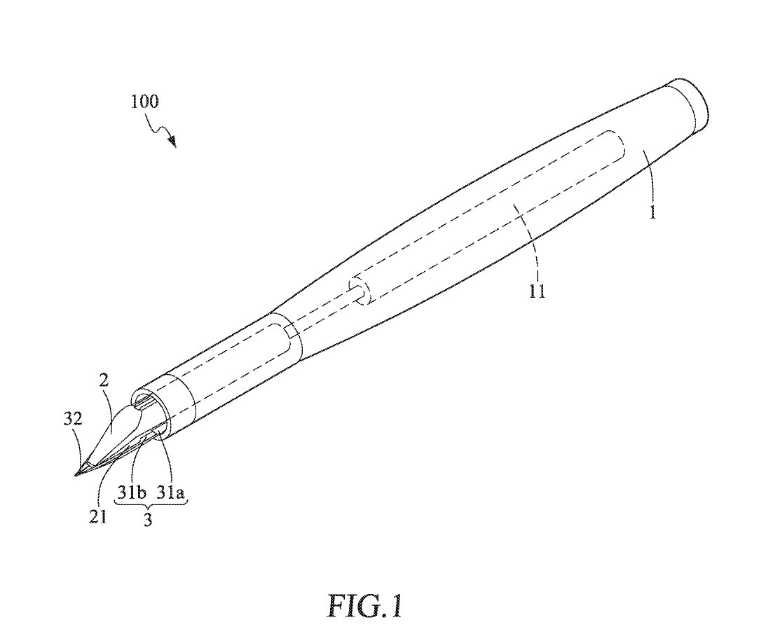

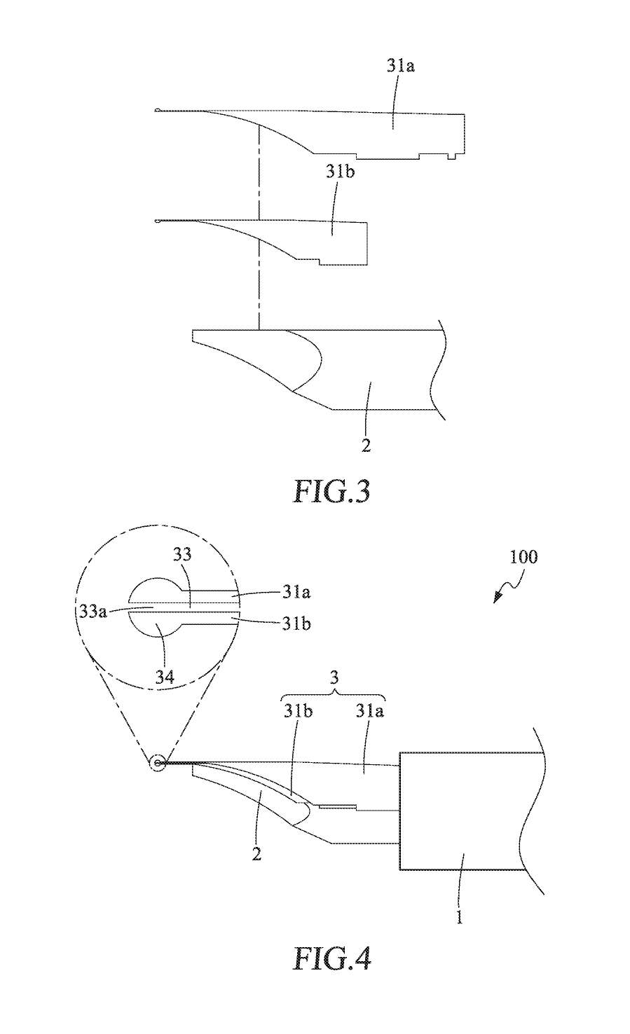

With reference to FIGS. 1 to 6, the embodiments of the present invention are described. The description does not limit the scope of the embodiments but is one of the embodiments of the present invention.

FIG. 1 to FIG. 5 illustrate an omnibearing writable fountain pen according to the first embodiment of the present invention, comprising: a shaft component 1 in which an ink reserve chamber 11 is contained; a feed component 2 arranged at the front end of the shaft component 1 to deliver ink reserved in the ink reserve chamber 11; a nib component 3 including two nibs 31a, 31b, each nib 31a, 31b having a middle slit 32, the two nibs 31a, 31b being stacked with each other in such a manner that a horizontal gap 33 is disposed between the two nibs 31a, 31b so as to form a nib tip 34 having at least four ink channels 32a, 33a in a front end of the two nibs, wherein each ink channel 32a, 33a is connected through the middle slit 32 and the feed component 2 to the ink reserve chamber 11.

In this embodiment, the nib component 3 is two detachable nibs 31a, 31b in order to facilitate the cleaning and maintenance of the nib component 3. The nib tip 34 at the front end of the two nibs 31a, 31b is Iridium point which is in form of a sphere in such a manner that the writing feeling remains the same no matter what writing angle and direction are. In the other embodiments, however, the nib tip 34 can also be in form of an ellipsoid or other shapes in order to create line variety through shape-changing of the nib tip 34.

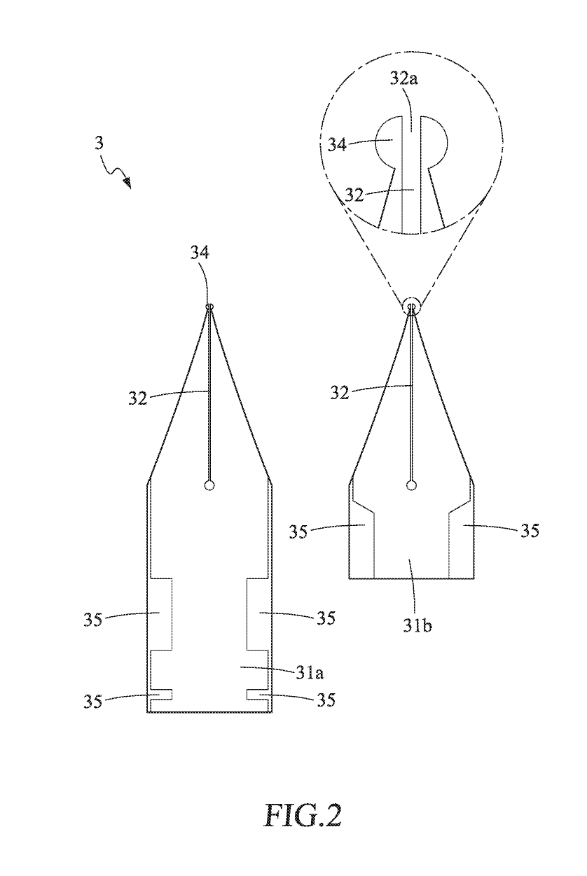

Moreover, the middle slit 32 and the horizontal gap 33 of the omnibearing writable fountain pen 100 according to the first embodiment of the present invention, as shown in FIG. 2 to FIG. 5, can both produce capillarity so as to attract the ink-flow to the nib tip 34 by means of the adhesion of the ink to the side wall surface of the middle slit 32 and the horizontal gap 33. The middle slit 32 extends along the center line of the nibs 31a, 31b to form the ink channels 32a on the front and rear sides of the nib tip 34 and the horizontal gap 33 forms the ink channels 33a on the left and right sides of the nib tip 34, these ink channels 32a, 33a being communicated with the ink reserve chamber 11 in such a manner that the front, rear, left and right sides of the nib tip 34 can have ink-flow. This advantageous characteristic combining with the adhesive force between ink and paper makes the omnibearing writable fountain pen of the present invention omnibearing writable

More specifically, the middle slit 32 and the horizontal gap 33 are disposed perpendicular to each other. The two ink channels 33a formed on the sphere by the horizontal gap 33 extends along a bisecting line of the sphere to bisect the sphere into two hemispheres located on the upper nib 31a and the lower nib 31b respectively; The two ink channels 32a formed on the sphere by the middle slit 32 extends along a center line of the nibs 31a, 31b to bisect the two hemispheres. As a result, a uniform distribution of the four ink channels 32a, 33a appears on the nib tip 34. In the other embodiments, however, more than three nibs can also be stacked with each other in such a manner that more than four ink channels can be formed on the nib tip 34.

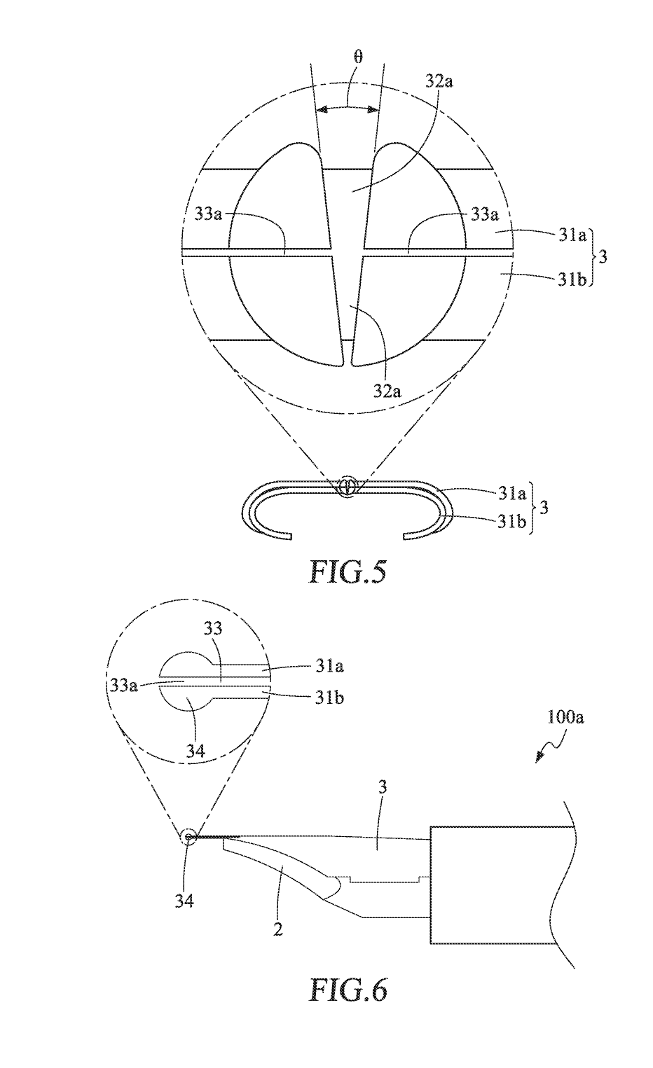

As shown in FIG. 5, the omnibearing writable fountain pen 100 according to the first embodiment of the present invention, an angle θ between two side wall surfaces, in up and down direction, of the ink channel 32a formed at the upper nib 31a is between 0°20′0″ and 0°30′0″. The two side wall surfaces of the ink channel 32a formed at the lower nib 31b can be parallel or form, in up and down direction, an angle θ between 0°20′0″ and 0°30′0″. As a result, there is a writing line thickness difference between writing right side up and writing upside down when using the omnibearing writable fountain pen 100 of the present invention, because of the difference existing in contact area between the nib tip 34 and paper and in volume of attracted ink-flow. Of course, depending on a special need of a user for writing line thickness in a certain orientation, the side wall surfaces of one or more corresponding ink channels 32a, 33a can be parallel or form an angle θ within an angle range between 0°20′0″ and 0°30′0″.

As shown in FIG. 1 and FIG. 2, the two nibs 31a, 31b of the nib component 3 each has a buckle element 35. In this embodiment, the buckle elements 35 are bumps arranged protruding out from the two sides of the two nibs 31a, 31b toward the center to buckle a buckle correspondence 21 of the feed component 2 in order to fix the nib component 3 to the feed component 2.

The omnibearing writable fountain pen according to the second embodiment of the present invention, as shown in FIG. 6, whose structure is generally the same as the omnibearing writable fountain pen of the first embodiment, and is different in that: the nib component 3 is a integrally formed structure in which the two nibs 31a, 31b are located at the front end of the nib component 3 and the buckle elements 35 are two bumps which fix the nib component 3 to the feed component 2.

The above description is only an explanation of the preferred embodiments of the present invention. One having ordinary skill in the art can make various modifications according to the above description and the claims defined below. However, those modifications shall still fall within the scope of the present invention.

What is claimed is:

1. An omnibearing writable fountain pen, comprising:
a shaft component in which an ink reserve chamber is contained;
a feed component arranged at the front end of the shaft component to deliver ink reserved in the ink reserve chamber;
a nib component including two nibs, each nib having a middle slit, the two nibs being stacked with each other in such a manner that a horizontal gap is disposed between the two nibs so as to form a nib tip having at least four ink channels in a front end of the two nibs,
wherein each ink channel is connected through the middle slit and the feed component to the ink reserve chamber.

2. The omnibearing writable fountain pen of claim 1, wherein the nib tip is in form of a sphere.

3. The omnibearing writable fountain pen of claim 2, wherein the sphere includes two hemispheres, each hemisphere located on one nib.

4. The omnibearing writable fountain pen of claim 1, wherein the nib component has a buckle element arranged to buckle a buckle correspondence of the feed component.

5. The omnibearing writable fountain pen of claim 2, wherein the horizontal gap extends along a bisecting line of the sphere to bisect the sphere.

6. The omnibearing writable fountain pen of claim 3, wherein the horizontal gap extends along a bisecting line of the sphere to bisect the sphere.

7. The omnibearing writable fountain pen of claim 3, wherein the middle slit extends along a center line of the nib to bisect the hemisphere.

8. The omnibearing writable fountain pen of claim 1, wherein the two nibs are arranged as an upper nib and a lower nib, an angle between two side wall surfaces, in up and down direction, of the middle slit formed at the upper nib is between 0°20′0″ and 0°30′0″.

9. The omnibearing writable fountain pen of claim 1, wherein the nib component is two detachable nibs.

10. The omnibearing writable fountain pen of claim 1, wherein the nib component is formed integrally.
